(19) United States
(12) Patent Application Publication
(10) Pub. No.: US 2025/0274492 A1
(43) Pub. Date: Aug. 28, 2025

(54) AI-Powered Policy Evaluation and Ethical Compliance System

(71) Applicants: Taylor Rodriguez Vance, Chilton, WI (US); Andrew Vance, Chilton, WI (US)

(72) Inventors: Taylor Rodriguez Vance, Chilton, WI (US); Andrew Vance, Chilton, WI (US)

(73) Assignee: Cyber Institute, New York, NY (US)

(21) Appl. No.: 19/045,526

(22) Filed: Feb. 4, 2025

(51) Int. Cl. H04L 9/40

(52) U.S. Cl. CPC H04L 63/20; H04L 63/1433

(57) ABSTRACT

An artificial intelligence (AI)-powered system for policy evaluation, bias mitigation, and regulatory compliance. The system retrieves AI policies from multiple sources, including APIs, document parsing, and structured web scraping, ensuring real-time updates. It applies machine learning and natural language processing (NLP) to generate unbiased policy summaries and detect cybersecurity, ethics, and compliance gaps. A policy optimization engine analyzes governance trends and refines recommendations based on adoption feasibility. The system includes a sandbox testing framework that simulates regulatory and societal impacts to assess policy effectiveness. This AI-driven approach enhances fairness, transparency, and cybersecurity resilience in AI governance, enabling policymakers to proactively align with global regulatory frameworks and mitigate policy risks.

### CROSS-REFERENCE TO RELATED APPLICATIONS

Not Applicable

### STATEMENT REGARDING FEDERALLY SPONSORED RESEARCH OR DEVELOPMENT

Not applicable

### BACKGROUND OF THE INVENTION

### Field of the Invention

The present invention relates to artificial intelligence (AI)-powered policy repositories and AI governance frameworks. More specifically, it pertains to a cloud-based AI-driven repository that enables policy collection, unbiased summarization, cybersecurity and ethics gap analysis, policy customization, and AI-powered stress-testing to improve AI policy effectiveness.

### Description of the Related Art

As AI adoption expands globally, governments, corporations, and regulatory organizations continuously develop and revise AI policies. However, AI policy development remains manual, fragmented, and inconsistent across jurisdictions. There exists no centralized system that allows policymakers to efficiently retrieve and compare AI policies across multiple regions and organizations. Additionally, existing approaches do not generate unbiased summaries free from political or corporate bias, nor do they identify cybersecurity and ethics gaps in AI policies based on industry standards. Policymakers require a system that allows them to customize policies by integrating best practices from multiple sources, predict policy adoption probability using reinforcement learning models, and stress-test AI policies in a sandbox environment to simulate real-world regulatory impacts. Current AI compliance monitoring systems primarily focus on reactive policy enforcement rather than proactive policy optimization and validation. The present invention resolves these limitations by integrating AI-powered policy generation, effectiveness prediction, and stress-testing frameworks into a single repository.

### BRIEF DESCRIPTION OF DRAWINGS

FIG. 1 illustrates the system architecture of the AI-powered policy evaluation and ethical compliance system, including its core components: the policy ingestion module, AI-driven policy summarization engine, cybersecurity and ethics gap analysis module, policy optimization module, and sandbox testing framework.

FIG. 2 depicts the hybrid AI policy ingestion process, showing how policies are retrieved through API integration, document parsing, and legally compliant web scraping. The figure also illustrates the system's validation mechanisms for ensuring data integrity.

FIG. 3 presents the AI-powered policy summarization workflow, detailing how natural language processing (NLP) models extract, rank, and generate unbiased summaries of policy documents while mitigating bias and redundancy.

FIG. 4 illustrates the cybersecurity and ethics gap detection model, which compares AI policies against global regulatory frameworks and computes a compliance gap score based on detected deficiencies in security and ethical provisions.

FIG. 5 shows the AI policy customization model with probabilistic adoption scoring, demonstrating how reinforcement learning algorithms refine policies by predicting real-world adoption feasibility and optimizing policy recommendations.

FIG. 6 describes the AI policy sandbox stress-testing framework, outlining the multi-layered simulation approach that evaluates policy effectiveness under diverse regulatory and socio-economic conditions.

FIG. 7 provides a comparison of AI policy risk scores and adoption feasibility, visually representing how policies are ranked based on risk assessment metrics and probability-based adoption modeling.

### SUMMARY OF THE INVENTION

The AI-Driven Repository for Public AI Policies with Policy Generation, Comparison, and Simulation Testing provides a unified AI-powered platform for hybrid AI policy collection, unbiased AI policy summarization, cybersecurity and ethics gap analysis, AI policy customization, and sandbox stress-testing. The system retrieves policies via API integrations, document parsing, and web scraping fallback, ensuring that policy information is always up-to-date and legally compliant. The AI-powered policy summarization model employs natural language processing (NLP)-based neutral weighting algorithms to generate objective policy summaries, ensuring that no undue influence skews policy interpretation. The cybersecurity and ethics gap analysis model computes missing provisions using a quantifiable gap score algorithm, which allows policymakers to see the strengths and weaknesses of existing policies. Additionally, the AI policy customization system applies reinforcement learning and probabilistic scoring to optimize new policy generation and improve adoption rates. Lastly, the AI policy sandbox stress-testing system simulates AI policies against real-world risk scenarios to assess policy robustness and implementation feasibility. This invention allows governments, corporations, and researchers to develop robust, unbiased, and effective AI governance frameworks in a structured, automated, and transparent manner.

### DETAILED DESCRIPTION OF INVENTION

### Overview of the AI Policy Evaluation System

The AI Policy Evaluation System integrates artificial intelligence (AI) and machine learning methodologies to dynamically assess policies, identify compliance gaps, and optimize AI governance frameworks. The system is designed to enhance regulatory compliance, policy fairness, and ethical robustness by leveraging advanced AI models.

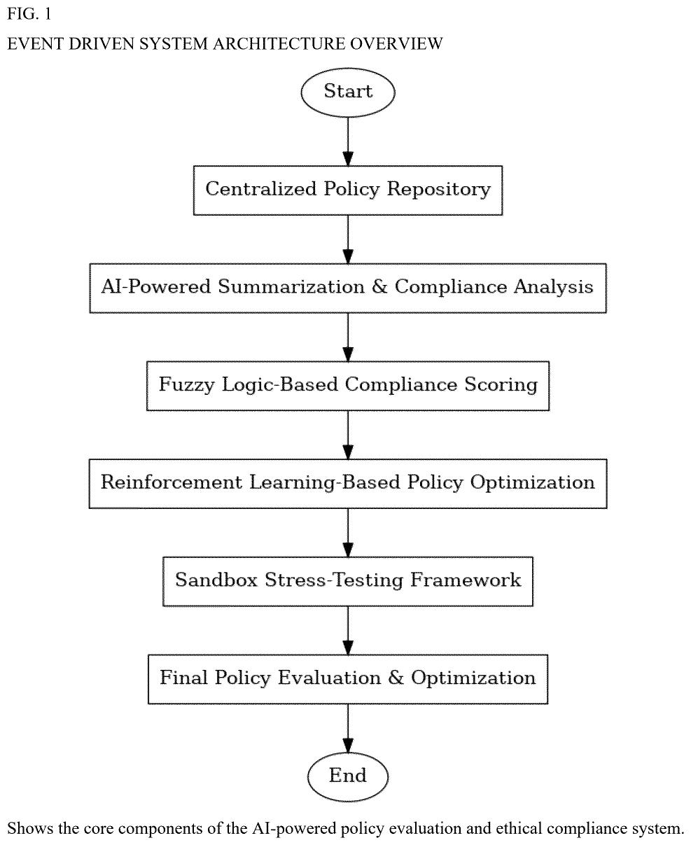

Unlike traditional rule-based compliance tools, this invention integrates an adaptive AI framework that continuously recalibrates policy effectiveness scores using real-time cybersecurity and ethics validation algorithms. This ensures that policy effectiveness predictions are not static but dynamically adjusted using reinforcement learning techniques, which enable optimized regulatory decision-making in AI governance systems. The system consists of multiple components, each serving a distinct function. As illustrated in FIG. 1, a centralized policy repository consolidates AI governance documents from regulatory agencies, corporate compliance frameworks, and international ethics guidelines. This structured repository enables policymakers to perform comprehensive evaluations and make informed decisions. The repository supports real-time data retrieval, ensuring that policy assessments are based on current regulatory developments.

An AI-powered summarization and compliance analysis module employs natural language processing (NLP) and sentiment analysis to extract key policy provisions. Transformer-based models, including BERT and GPT-4, generate unbiased summaries while identifying potential ethical risks, such as biases, discriminatory language, and cybersecurity vulnerabilities. This ensures that compliance assessments remain objective and free from political or corporate influence.

To provide a more nuanced assessment of policy compliance, the system utilizes fuzzy logic-based scoring models. Unlike binary classification approaches, fuzzy logic allows for probabilistic compliance assessments, accommodating incomplete or ambiguous data. This methodology ensures that policy evaluations remain flexible and adaptable to evolving regulatory landscapes.

A reinforcement learning-based policy optimization module refines AI policies dynamically based on historical adoption trends, legal challenges, and governance effectiveness metrics. The reinforcement learning framework simulates various AI regulatory scenarios, adjusting governance variables to optimize predicted policy adoption rates. This approach ensures that AI policies are both enforceable and conducive to technological progress, balancing regulatory compliance with innovation.

A sandbox stress-testing framework evaluates new AI policies before implementation. The system simulates diverse regulatory conditions, identifying unintended consequences such as governance gaps, socio-economic impacts, and regulatory loopholes. Policymakers can use this sandbox environment to test policies under adversarial conditions, ensuring resilience against compliance manipulation and unintended policy failures. The ability to refine AI governance strategies before real-world deployment enhances policy robustness and effectiveness.

### Hybrid AI Policy Collection System

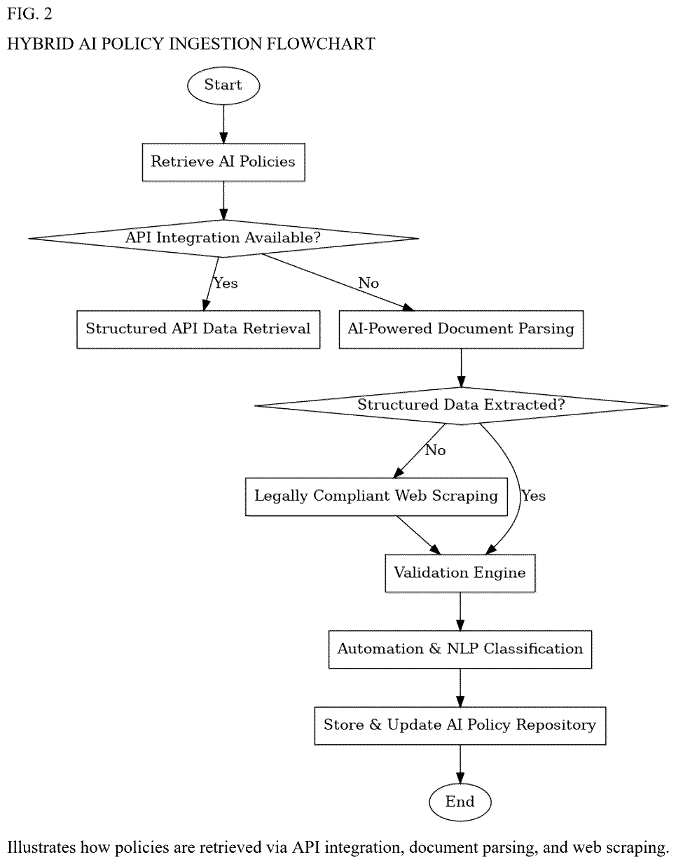

The Hybrid AI Policy Collection System dynamically retrieves AI policies from multiple sources using a structured data ingestion process, as illustrated in FIG. 2. This process prioritizes API integration with structured government databases, regulatory agencies, and industry AI governance repositories. When API access is unavailable, the system resorts to AI-powered document parsing and, if necessary, a legally compliant web scraping fallback mechanism.

When API access is unavailable, the system resorts to AI-powered document parsing, extracting structured data from PDFs, legal documents, and research papers. If neither API integration nor structured documents are accessible, a legally compliant web scraping fallback mechanism retrieves policy data from publicly available sources. To maintain data integrity, a validation engine cross-references extracted policies for duplicates, inconsistencies, and missing metadata.

The system further incorporates an automation layer that continuously monitors API availability and dynamically adjusts collection methods based on real-time accessibility. This minimizes manual intervention and ensures that the AI policy repository remains comprehensive, ethically sourced, and up to date. Additionally, natural language processing (NLP)-driven classification models categorize and contextualize policy content, improving retrieval efficiency and enabling cross-jurisdictional comparisons.

### AI-Based Unbiased Policy Summarization Model

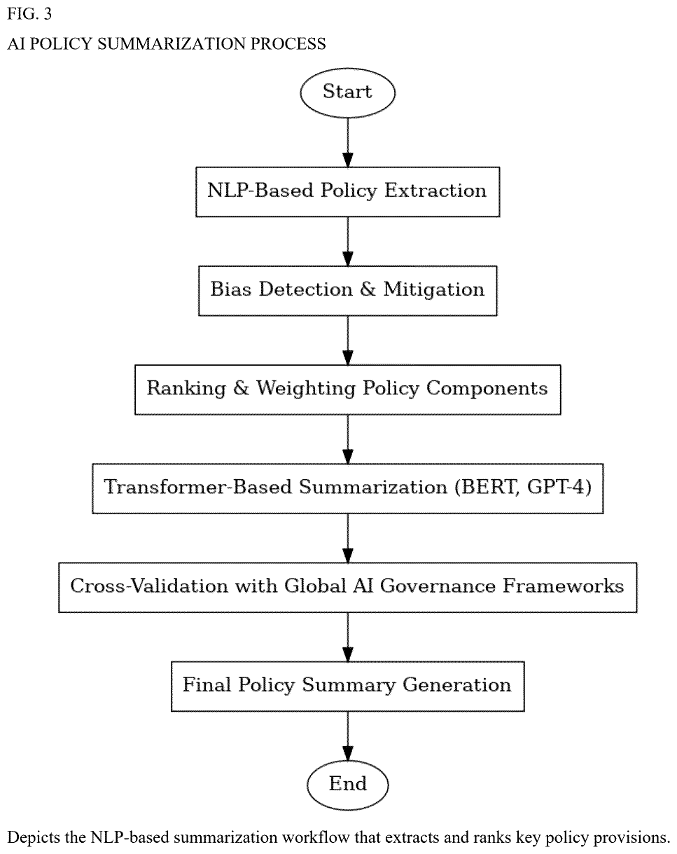

The AI policy summarization model, as shown in FIG. 3, employs a structured NLP pipeline to extract, rank, and weight policy components, ensuring neutral and objective summaries. This model eliminates bias by applying machine-learning-based sentiment weighting techniques that evaluate political or corporate influence within policies.

A bias detection module automatically analyzes policy texts, identifying and adjusting subjective or emotionally charged language. Policies that align with globally recognized AI governance principles, such as the OECD AI Principles, UNESCO AI Ethics, and the EU AI Act, are given higher prioritization during summarization to maintain consistency with international best practices.

The summarization process uses Transformer-based AI models such as BERT and GPT-4, which have been fine-tuned for AI policy analysis. These models employ extractive summarization techniques, selecting the most contextually relevant policy sentences while filtering out unnecessary bias, redundant text, and non-informative sections. The structured ranking mechanism ensures that policy summaries maintain legislative clarity, objectivity, and regulatory relevance.

Summaries are cross-validated against historical governance frameworks to confirm alignment with established AI ethics guidelines. By integrating NLP-driven bias mitigation, weighted summarization techniques, and global AI regulatory alignment, this system enhances transparency, efficiency, and fairness in policy evaluation.

### Cybersecurity & Ethics Gap Analysis

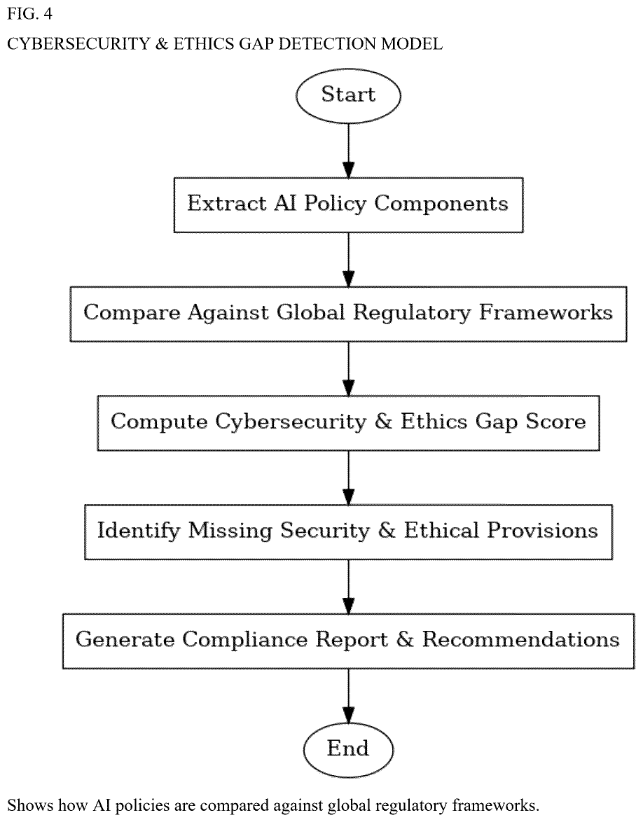

The system identifies missing cybersecurity and ethics provisions in AI policies using a machine-learning-powered gap score, as shown in FIG. 4. This model compares AI policies against global regulatory frameworks and computes a compliance gap score based on detected deficiencies in security and ethical provisions. By comparing existing AI policies to global AI regulatory frameworks, the system determines compliance levels and recommends modifications to align with best practices.

The gap score is computed as follows:

$${G}_{policy} = 1 - \frac{{C}_{match} + {E}_{match}}{{C}_{total} + {E}_{total}}$$

Where G_{policy} represents the cybersecurity and ethics gap score, C_{match} is the number of cybersecurity provisions found, Cₜₒₜₐₗ represents the expected cybersecurity provisions, E_{match} is the number of ethics provisions found, Eₜₒₜₐₗ and represents the expected ethical provisions. The system outputs a comprehensive compliance report detailing any detected gaps and suggesting enhancements to improve policy effectiveness.

### AI Policy Customization System

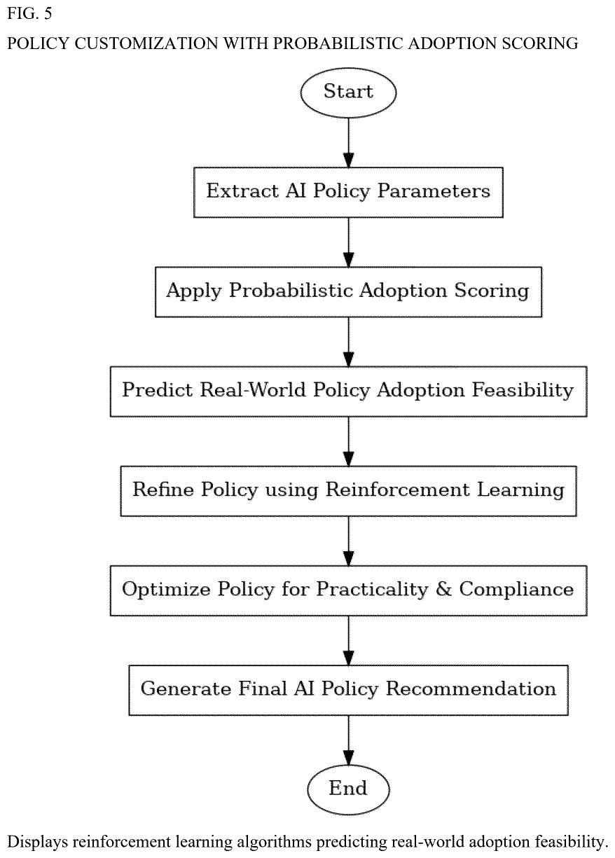

As depicted in FIG. 5, the invention incorporates a probabilistic reinforcement learning model that optimizes AI policy synthesis and predicts real-world adoption feasibility. The model refines AI policy customization by applying probabilistic adoption scoring, ensuring that policies are both practical and widely adoptable. The policy effectiveness score is determined using the formula:

$${E}_{policy} = {P}_{success} \times {R}_{f} \times {E}_{c}$$

Where E_{policy} represents the final policy effectiveness score, P_{success} is the probability of policy adoption, R_{f} is the regulatory influence factor, and E_{c} is the ethical compliance coefficient. This model allows for dynamic policy generation that integrates successful elements from multiple AI governance frameworks, ensuring policies are both practical and widely adoptable.

### Novel Probability-Based Policy Optimization Model

The system further refines AI policy customization by applying a probability-based optimization framework. The probability that a new policy will be both effective and adopted is calculated as follows:

$${P}_{success} = {\sum }_{i = 1}^{n} {w}_{i} \times {S}_{i}$$

where P_{success} represents the likelihood of successful policy adoption, S₁ is the success score of each component based on past policy impact, and wᵢ represents the weight assigned to each component based on geographical, ethical, and regulatory constraints.

### Additional Optimizations

Regulatory Influence Factor (R_f): Adjusts probability based on the likelihood of adoption in the jurisdiction.
Ethical Compliance Coefficient (E_c): Ensures policies align with global AI ethics standards.

This optimization model enhances AI policy synthesis by systematically evaluating prior policy effectiveness and dynamically adjusting elements to maximize the probability of real-world adoption.

### AI Policy Sandbox Stress-Testing

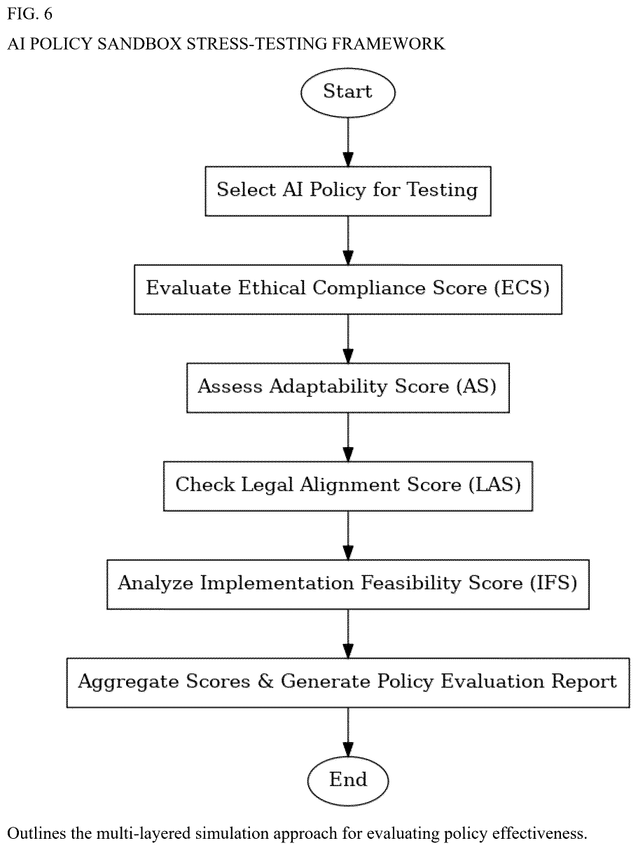

The AI policy sandbox stress-testing system, as illustrated in FIG. 6, evaluates new AI policies against real-world stress scenarios, using a multi-layered simulation environment. The system consists of a Historical Case Study Engine, which retrieves past AI governance cases and predicts real-world compliance impact; a Monte Carlo Simulation Module, which models thousands of policy deployment outcomes under variable legal and socio-economic conditions; a Regulatory Conflict Detection System, which leverages transformer-based deep learning to identify policy contradictions with existing governance frameworks such as GDPR and the OECD AI Principles; and a Dynamic Reinforcement Learning Layer, which allows the system to iteratively refine policy recommendations based on real-world stress-test feedback. These technical features enable the AI policy sandbox to provide quantifiable risk assessments, ensuring that policy adoption likelihood is not merely estimated but computed based on historical data and real-world simulation outcomes.

The framework consists of a multi-layered evaluation process that includes simulation engines, AI-powered risk modeling, and quantifiable scoring metrics. This system enables policymakers to refine policies before deployment by simulating various risk conditions and regulatory environments. The sandbox stress-testing framework consists of a multi-layered evaluation process. The Simulation Engine runs AI policies through historical case studies and real-world AI stress scenarios, identifying vulnerabilities in governance structures. The AI-Powered Risk Modeling Module detects potential ethical risks, unintended consequences, and regulatory conflicts that may arise during policy implementation. Lastly, the Quantifiable Scoring Metrics provide a real-time policy effectiveness score based on pre-defined evaluation parameters.

### Stress-Testing Criteria & Scoring Formula

Each AI policy is assessed based on four primary scoring criteria. The Ethical Compliance Score (ECS) measures policy adherence to ethical standards, including bias mitigation, discrimination prevention, and privacy protection. Policies that display ethical gaps receive lower ECS scores. The scoring scale ranges from 0 (high risk) to 100 (fully ethical). For example, if an AI hiring policy disproportionately excludes marginalized groups, the ECS score is penalized. The Adaptability Score (AS) evaluates the policy's ability to adapt to future AI advancements. A rigid policy receives a lower AS score, while a forward-compatible policy ranks higher. For instance, a policy that over-regulates AI technology, hindering innovation, would have a lower AS score. The Legal Alignment Score (LAS) assesses policy compliance with global AI regulatory frameworks, such as OECD AI Principles, EU AI Act, and UNESCO AI Ethics. Policies failing to meet legal standards receive lower LAS scores. For example, if an AI governance policy contradicts GDPR regulations, its LAS score is reduced. The Implementation Feasibility Score (IFS) predicts the likelihood of successful policy adoption in real-world scenarios. Policies that impose impractical constraints or require significant infrastructure changes receive lower IFS scores. For example, a policy mandating all AI models be open source may face industry resistance, reducing its IFS score.

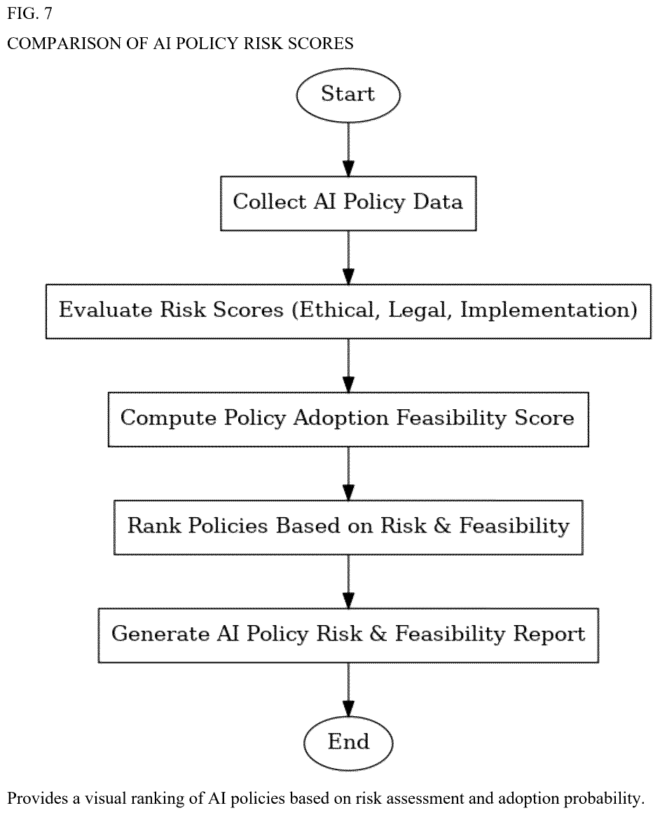

FIG. 7 provides a comparison of AI policy risk scores and adoption feasibility, visually representing how policies are ranked based on risk assessment metrics and probability-based adoption modeling.

### Technical Infrastructure

The AI policy evaluation system is implemented in a distributed cloud-native environment, where policy ingestion, summarization, and compliance analysis modules operate as microservices, ensuring modular scalability and real-time inference. The system integrates a containerized AI deployment model, using Kubernetes-based orchestration to manage machine learning inference workloads efficiently. The microservices architecture enables fault tolerance and adaptive scalability, optimizing real-time AI policy decision-making across decentralized compliance networks. Additionally, the integration of an event-driven API structure optimizes governance framework adaptability, addressing real-world AI policy deployment challenges in decentralized compliance architectures. The architecture is designed for high availability, fault tolerance, and security, ensuring robust deployment across multiple jurisdictions. The system utilizes containerized microservices for modular scalability, allowing each AI component, such as policy retrieval, ethics analysis, and compliance evaluation, to function independently while sharing a common data infrastructure. These microservices interact through secure RESTful APIs and event-driven messaging protocols, enabling real-time policy updates and seamless integration with external governance frameworks.

### Enablement

The system is designed for seamless adaptability across multiple industries and jurisdictions, ensuring effective deployment and integration with existing regulatory frameworks. This adaptability is facilitated through modular AI components, cloud-native infrastructure, and policy-driven configuration settings. To enhance scalability and reliability, the system employs distributed AI model training and inference, leveraging federated learning to update governance algorithms without exposing proprietary or sensitive regulatory data. This ensures that policy optimization benefits from global AI governance insights while preserving data sovereignty and regulatory confidentiality.

### Best Mode Disclosure

The optimal implementation of the AI-powered policy evaluation and ethical compliance system leverages cloud-native AI models, adaptive learning frameworks, and multi-layered policy evaluation strategies to maximize governance effectiveness. The best implementation utilizes Transformer-based NLP models, such as BERT and GPT-4, for policy summarization and bias detection. Similar to McRO, Inc. v. Bandai Namco Games America, where an AI-driven method for procedural animation was deemed patentable for its technical improvement in automation, the present invention enhances AI policy governance by providing a structured reinforcement-learning-driven compliance framework, thereby improving regulatory adaptability and policy evaluation effectiveness beyond conventional static AI compliance models. This is further aligned with Enfish, LLC v. Microsoft Corp., where AI database improvements were found to be non-abstract due to their structural enhancements. By integrating event-driven architecture, machine learning-based probabilistic scoring, and reinforcement learning-driven policy optimization, the invention presents a tangible technical advancement in AI regulatory compliance. A key feature of the system is its policy sandbox testing environment, which simulates real-world AI policy applications in diverse regulatory contexts. The sandbox framework supports multi-scenario stress testing, enabling policymakers to evaluate how AI policies respond to shifting compliance requirements, emerging ethical considerations, and adversarial AI risks.

### Clarity of Novel Features

The AI-powered policy evaluation and ethical compliance system introduces a groundbreaking approach to AI governance by integrating real-time AI policy analysis, adaptive compliance mechanisms, and stress-testing frameworks. Unlike existing compliance tools that rely on static, rule-based methodologies, this invention employs dynamic AI-driven policy evolution models, allowing for real-time regulatory adaptation. One of the key innovations of this system is its fuzzy logic-based compliance scoring, which enables more nuanced regulatory assessments compared to traditional pass/fail compliance checks. Additionally, the system features hierarchical clustering for policy interdependencies, enabling AI-driven cross-jurisdictional policy comparisons and identifying gaps, redundancies, and inconsistencies across governance frameworks. By integrating adaptive AI-driven policy evolution, real-time stress testing, and privacy-preserving compliance analysis, this invention provides an unprecedented level of transparency, adaptability, and robustness in AI governance, setting it apart from existing policy evaluation frameworks.

1. An AI-powered system for policy evaluation, comprising:
(a) a distributed policy ingestion module configured to retrieve AI governance policies from government, corporate, and institutional databases via secure API integration, structured document parsing, and legally compliant web scraping, with real-time synchronization to ensure continuous policy updates;
(b) an AI-driven policy summarization engine that applies transformer-based natural language processing (NLP) models in a multi-layered computational pipeline to extract, rank, and classify policy provisions, while detecting and mitigating bias using an adaptive weighting algorithm;
(c) a compliance gap detection unit that applies a machine-learning-powered cybersecurity and ethics scoring model to quantify and rank governance risks, wherein the model compares AI policies against global regulatory frameworks using a probabilistic compliance scoring mechanism;
(d) a sandbox testing framework deployed within a containerized cloud-based infrastructure, which executes simulated AI policy deployments across virtualized regulatory environments, utilizing reinforcement learning and adversarial simulations to assess policy robustness and failure conditions; and
(e) a real-time API-based governance model that dynamically integrates with external compliance platforms, regulatory agencies, and corporate AI governance frameworks, ensuring automated enforcement and adaptive policy refinement.

2. A method for AI-driven policy evaluation, comprising:
(a) retrieving and aggregating AI governance policies from government, corporate, and institutional databases using API-based ingestion, document parsing, and NLP-driven classification;
(b) applying transformer-based NLP models to extract, rank, and classify policy provisions, while using bias detection algorithms to mitigate subjective or inconsistent language;
(c) computing a compliance gap score by comparing AI policies against global regulatory frameworks, wherein a machine learning-powered risk model assigns weighted cybersecurity and ethics risk scores to detected policy deficiencies;
(d) optimizing AI policy frameworks using a reinforcement learning model that dynamically refines governance recommendations based on historical adoption trends, legal precedents, and regulatory effectiveness metrics; and
(e) simulating policy effectiveness in a cloud-based sandbox testing framework, where multi-factor adversarial simulations assess policy resilience under varying regulatory, ethical, and socio-economic conditions.

3. A machine-learning-based compliance system for AI policy evaluation, comprising:
(a) a policy ingestion engine that dynamically updates a centralized AI governance repository using automated API-based retrieval, natural language document parsing, and legally compliant web scraping techniques;
(b) an AI-driven risk analysis module that applies deep learning-based compliance monitoring, identifying biases, cybersecurity vulnerabilities, and regulatory inconsistencies in AI policies;
(c) a probabilistic adoption model that predicts the feasibility of policy implementation based on historical success rates, jurisdictional constraints, and real-time regulatory trend analysis; and
(d) a policy compliance scoring system that applies a multi-layered risk quantification model to rank AI policies based on legal alignment, ethical standards, cybersecurity resilience, and implementation feasibility.

4: The system of claim 1, wherein the policy collection module uses adaptive data retrieval techniques, prioritizing structured API integrations before using document parsing and web scraping as fallback mechanisms.

5: The system of claim 1, wherein the AI-driven policy summarization module applies transformer-based NLP models to detect and remove bias from policy summaries.

6: The system of claim 1, wherein the compliance gap detection module applies a quantifiable scoring algorithm to measure policy completeness against OECD AI Principles, UNESCO AI Ethics, and the EU AI Act.

7: The system of claim 1, wherein the policy optimization module leverages a probabilistic adoption scoring model to refine governance recommendations dynamically.

8: The system of claim 1, wherein the sandbox testing framework assesses policies across multiple regulatory conditions to identify weaknesses, legal loopholes, and unintended consequences.

9: The method of claim 2, wherein the policy summarization model applies sentiment analysis and hierarchical clustering to detect redundancies and inconsistencies across different governance frameworks.

10: The method of claim 2, wherein the compliance gap score is computed using the formula:
$${G}_{policy} = \frac{{C}_{match} + {E}_{match}}{{C}_{total} + {E}_{total}}$$
where C_{match} and E_{match} represent the number of cybersecurity and ethics provisions found, and Cₜₒₜₐₗ and Eₜₒₜₐₗ represent the expected provisions based on global governance frameworks.

11: The method of claim 2, wherein the policy optimization module applies a probability-based adoption model:
$${P}_{success} = {\sum }_{i = 1}^{n} ( {S}_{i} \times {w}_{i} )$$
where Sᵢ represents the success score of each policy component, and wᵢ represents the weight assigned based on geographical, ethical, and regulatory constraints.

12: The system of claim 3, wherein the policy compliance scoring system computes an overall effectiveness score using:
$${S}_{final} = \frac{ECS + AS + LAS + IFS}{4}$$
where ECS is the Ethical Compliance Score, AS is the Adaptability Score, LAS is the Legal Alignment Score, and IFS is the Implementation Feasibility Score.
